(19) United States
(12) Patent Application Publication
(10) Pub. No.: US 2012/0304646 A1
(43) Pub. Date: Dec. 6, 2012

(54) METHOD AND APPARATUS FOR REPAIRING AN ENGINE COMPONENT

(76) Inventors: Leonard Paul Palmisano, Forestville, CT (US); Robert J. DeRosa, Tolland, CT (US); William Bogue, Hebron, CT (US)

(21) Appl. No.: 13/149,145

(22) Filed: May 31, 2011

(51) Int. Cl. F16M 7/00; F02C 7/00; B23P 6/00; B32B 3/02

(52) U.S. Cl. 60/721; 428/81; 428/64.1; 29/402.06

(57) ABSTRACT

A shim is provided for repairing damage in a surface of a mechanical piece at or near an outer edge of a bore in the surface. The damage may penetrate a given distance within the surface and the bore is in close proximity to an attachment hole. The shim has a body having a first side and a second side and a thickness therebetween that is equal to or greater than the depth of the damage penetrating the given distance and contiguous to the attachment opening, wherein the body fits within an area machined into an outer surface surrounding the bore.

### STATEMENT REGARDING FEDERALLY SPONSORED RESEARCH OR DEVELOPMENT

This invention was made with Government support under F33657-99-D-2051 awarded by The United States Air Force. The Government has certain rights in this invention.

### BACKGROUND

It is common that machinery is made of functional modules that attach to each other usually by means of bolts, clamps, screws and the like. Common openings between modules may allow for the transfer of fluids such as gasses or liquids, and mechanical, electrical or other types of energy to enable adjacent modules to cooperate.

If the modules are separated, it is important that the areas that link the modules together are not damaged to avoid leaks, contamination, inefficiencies or the like.

If an edge of a circular opening, for instance, gets nicked, it is typical to machine the bore of the opening to remove enough material to eliminate the damage. A bead or an insert is then welded to the bore to rebuild the bore of the opening to its initial tolerance.

### SUMMARY

According to an embodiment disclosed herein, a shim is provided for repairing damage in a surface of a mechanical piece at or near an outer edge of a bore in the surface. The damage may penetrate a given distance within the surface and the bore is in close proximity to an attachment hole. The shim has a body having a first side and a second side and a thickness therebetween that is equal to or greater than the depth of the damage penetrating the given distance and contiguous to the attachment opening, wherein the body fits within an area machined into an outer surface surrounding the bore.

According to a further embodiment disclosed herein, an assembly for repairing damage in a gas turbine engine includes a gas turbine engine component that has a bore and a machined area disposed on an outside surface of the component contiguous to the bore. The machined area has a first depth equal to or greater than a depth of damage to the component. A shim has a body having a first side and a second side and a thickness therebetween that is equal to the first depth, wherein the body fits within the machined area and is flush thereto.

According to a further embodiment disclosed herein, a method of repairing damage in a gas turbine engine component includes: locating damage in a surface of the component in proximity to or within an edge of a bore; machining an area into an outer surface of the component in proximity to and touching the bore to a first depth that is equal to or greater than a depth of the damage in the outer surface; and inserting a shim into the area, the shim having a body having a first side and a second side and a thickness therebetween that is equal to the first depth wherein the shim is flush with the surface.

The various features and advantages of the disclosed examples will become apparent to those skilled in the art from the following detailed description. The drawings that accompany the detailed description can be briefly described as follows.

### BRIEF DESCRIPTION OF THE DRAWINGS

FIG. 1 shows a side, sectional view of a gear box for a jet engine incorporating a plurality of shims as described herein.

FIG. 2 shows an orthogonal view of a representative opening in a gear box as shown in FIG. 1.

FIG. 3 is a plan view of a shim that is installed in the gear box of FIG. 1.

FIG. 4 is a side view of the shim of FIG. 2.

### DETAILED DESCRIPTION

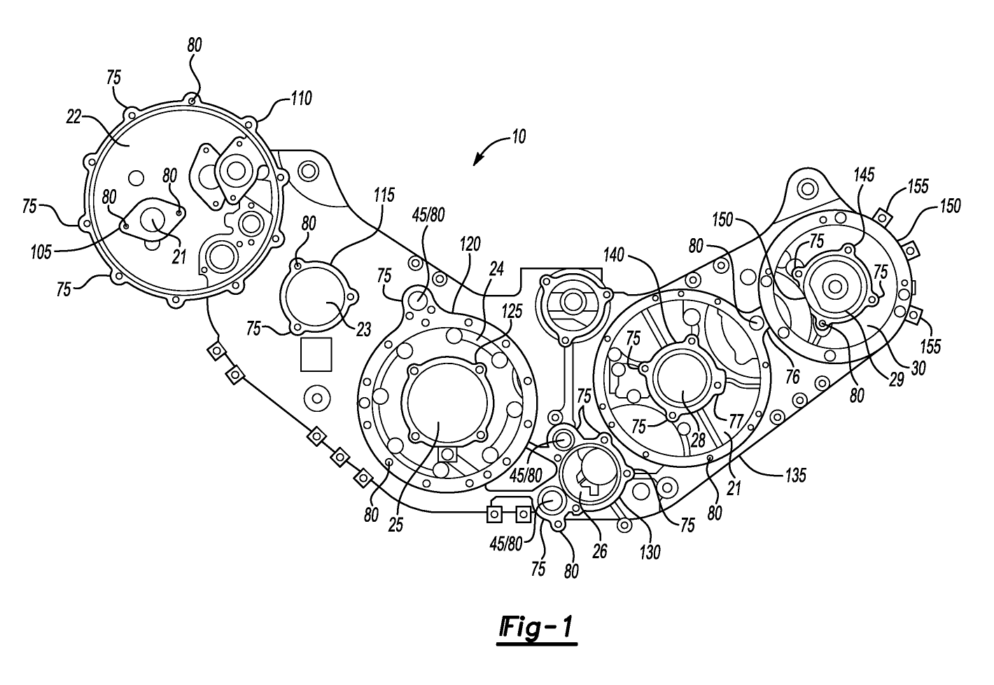

Referring to FIG. 1, the side, sectional view of a mechanical piece, such as a gas turbine engine gear box, 10 is shown. The gear box 10 has a multitude of representative openings 21, 22, 23, 24, 25, 26, 27, 28, 29, and 30 that bolt, or otherwise attach, to another half (not shown) of a casing or to other individual pieces of machinery (not shown). This particular type of gear box is constructed of cast magnesium or aluminum and is therefore more susceptible to damage than harder, but heavier, materials.

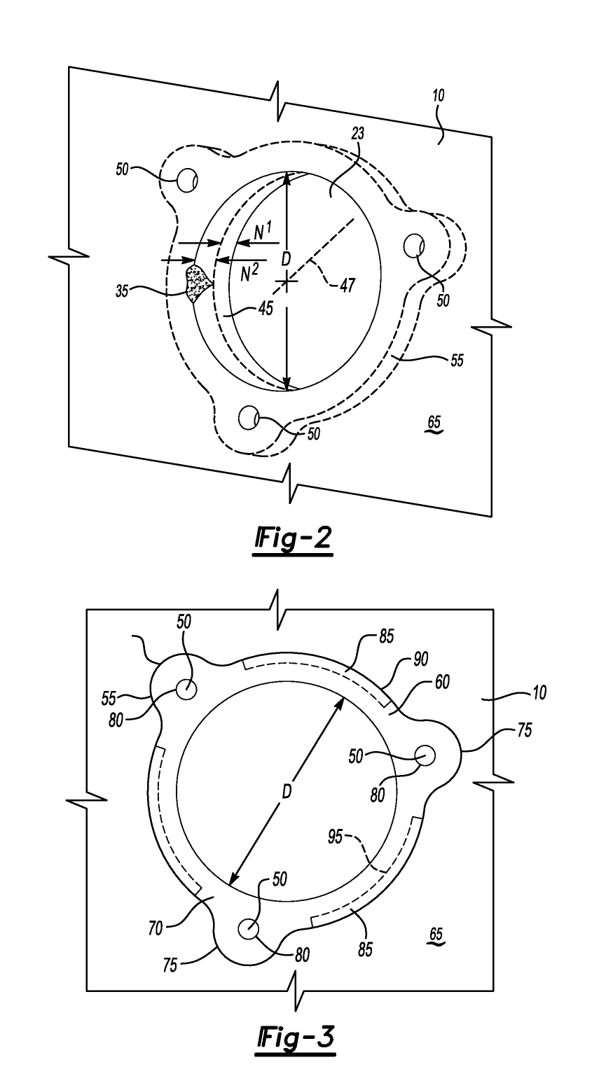

Referring now to FIG. 2, if the gear box 10, or other machinery, is assembled or disassembled damage, such as nick 35, to an edge 40 (or in proximity to) of opening 23 may occur particularly because of the softer, but lighter materials required for aircraft applications. Opening 23 has a central bore 45 having a diameter D disposed about axis 47 and is surrounded by three bolt holes 50 so that an accessory (not shown) may be bolted to the gear box 10. The nick extends into the bore a distance N¹ and into the surrounding gear box 10 a distance N².

In the past, the bore diameter D was machined out the distance N² to eliminate the nick, but the Applicants have discovered that there are two distinct problems with such actions: it can be seen in FIG. 1 that there are so many openings 21-30 that are close to each other that increasing the bore diameter D may not be possible without damaging other openings 21-30 or other holes 50; and, repairing the bore to its initial tolerances usually required higher temperatures, like for welding a bead or an insert, that tends to warp the gear box 10 and cause holes 50 to migrate and misalign with holes on other machinery modules (not shown) which required other costly repairs.

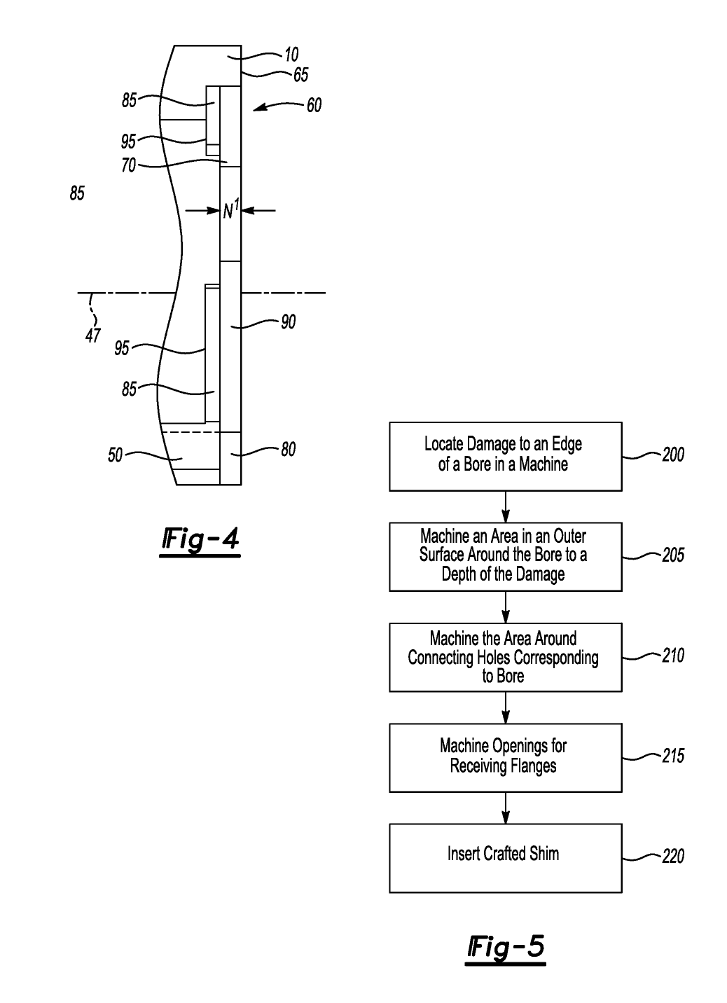

In the disclosed embodiment, instead of machining out the bore 45, an area 55 corresponding to the shape of a shim 60 (see also FIGS. 3 and 4) is machined into the outer surface 65 of the gear box 10 a distance N¹ to eliminate the nick 35. By using the shim 60, no high temperatures are needed for repair and there is no interference with other holes 21-30.

Referring now to FIGS. 3 and 4, an exemplar shim 60 is shown in place in area 55 on a gear box 10. The shim 60 has a flat, annular (though other shapes are contemplated herein), body 70 with a plurality of lobes 75 extending radially outwardly from the body 70. Each lobe 75, which may be differently or even oddly shaped depending on the shape of the gear box 10 or other machinery, has an opening 80 extending therethrough that are placed to be in register with holes 50 so that bolts (not shown) may join the gear box halves without modification. The shim 60 has a diameter D which is the same as the bore 45 thereby effecting repair.

The body 70 may have a plurality flanges 85 disposed around the outer edges 90 of the body. The area 55 may have a deeper opening 95 machined therein for receiving the flanges 85 therein. The flanges 85 and openings 95 act to locate the ship properly within the area 55.

Referring to the FIG. 5, a method for applying a shim 60 is shown. A damaged bore 45 in a machine is located (step 200). An area 55 is machined into the surface 65 around the bore 45 to the depth N² of the damage (e.g., nick 35) around the bore and is shaped to receive the shim (step 205). The area 55 may also include openings for receiving connectors (not shown) corresponding to the bore 45 (step 210). The area 55 may have openings 95 machined deeper therein to receive shim flanges 85 (step 215). A crafted shim 60 having flanges 85 extending therefrom to mate approximately with openings 95 and having a body 70 with a depth N² is inserted into the area 55 (step 220) and the bore and its surrounding surface is now back to original spec without warpage or damage to adjacent openings. Because the shapes of the openings 21-30 and the shapes of damage (e.g., nick 35) to them are so varied, the shim may need to be constructed for each application. In areas 55 where the machine casing 10 is not thick enough, the flanges 85 may be eliminated from the design. Existing bolt holes 50 are always used to place the shims to avoid extra work in the machining or interfering with required tolerances. As stated hereinbelow, the shim may be made of or coated with different materials.

The shim 60 and its lobes 75 may take many shapes and may repair more than one nick 35 on more than one bore 45. For instance, shim 105 about opening 21 has an ovate shape with two holes 80. Shim 110 is circular and has a plurality of crafted lobes 75 extending outwardly from the body 70 of the shim 60. Shim 115, which is seen in FIGS. 2-4, has three lobes 75 about its circumference. Shim 120 has one lobe 75 extending therefrom, which may be an opening 80 or another bore 45 and a plurality of openings 80 distributed around the body 70. Shim 125 has four regularly spaced lobes 75 extending thereabouts. Shim 130 has four lobes 75 (two of which are larger) which may also correspond to other bores 45. Shim 135 shows one large lobe 76 which is square shaped, and several openings 80 around the circumference of the shim 135. Shim 140 has four lobes with three lobes 75 regularly shaped and a fourth lobe 77 with a rectangular shape. Shim 145 has four regular lobes 75 and a break 150 in its circumference. Shim 150 has no lobes but does have a plurality of tabs 155 extending therefrom.

The shim 60 material may also be crafted by constructing or coating it with different materials or coatings to enhance the functionality of the gear box 10. For instance, if the second half (not shown) of the gearbox 10 or other connectors (not shown) are made of a hard material, relative motion therebetween tends to damage the gearbox that is constructed of generally softer magnesium or aluminum. The shim 60 may be coated or constructed of a harder material such as an oxide, or coated with a lubricious material such as PTFE. The shim 60 may also be coated with a thermal spray or a PVD coating. If electrical resistance between the parts is desired, the shim may be made of an oxide or painted. Similarly if electrical resistance between the parts is not desired, the shim may be made of or coated with an inorganic material or anodized. Also, the part may have an inert coating for chemical resistance. Other coatings and materials for the shim 60 are contemplated herein depending on the shim environment and the types of parts used therewith.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A shim for repairing damage in a surface of a mechanic piece at or near an outer edge of a bore in said surface, said damage penetrating a given distance within said surface, said bore having an attachment opening in close proximity to said bore, said shim comprising:
a body having a first side and a second side and a thickness therebetween that is equal to or greater than said depth of said damage penetrating said given distance and contiguous to said attachment opening, wherein said body fits within an area machined into an outer surface surrounding said bore.

2. The shim of claim 1 wherein said body has an annular shape.

3. The shim of claim 2 wherein said body is not continuous.

4. The shim of claim 1 wherein said first side of said body has a locating flange disposed therein for fitting within a corresponding groove disposed in said area.

5. The shim of claim 1 wherein said body further comprises a lobe for extending around said attachment opening.

6. The shim of claim 1 wherein said shim is constructed of a different material than said surface.

7. The shim of claim 1 wherein said shim has a coating thereon.

8. An assembly for repairing damage in a gas turbine engine, said assembly comprising:
a gas turbine engine component, said component having
a bore, and
a machined area disposed on an outside surface of said component contiguous to said bore, said machined area having a first depth equal to or greater than a depth of damage to said component,
a shim having a body having a first side and a second side and a thickness therebetween that is equal to said first depth, wherein said body fits within said machined area and is flush thereto.

9. The assembly of claim 8 further comprising said machined area encompassing an attachment hole for joining to said gas turbine engine component.

10. The assembly of claim 8 wherein said machined area further comprises a second bore that is not an attachment hole.

11. The shim of claim 8 wherein said first side of said body has a locating flange for fitting within a corresponding groove disposed in said area.

12. The shim of claim 8 wherein said body further comprises a lobe for extending around an attachment opening.

13. The shim of claim 8 wherein said shim is constructed of a different material than said component or has a coating thereon.

14. A method of repairing damage in a gas turbine engine component comprising:
locating damage in a surface of said component in proximity to or within an edge of a bore,
machining an area into an outer surface of said component in proximity to and touching said bore to a first depth that is equal to or greater than a depth of said damage in said outer surface,
inserting a shim into said area, said shim having a body having a first side and a second side and a thickness therebetween that is equal to said first depth wherein said shim is flush with said surface.

15. The method of claim 14 further comprising:
including attachment holes in said area in proximity to said bore.

16. The method of claim 15 further comprising:
defining a lobe in said shim, said lobe contiguous to said attachment holes if said shim is inserted into said area.

17. The method of claim 15 further comprising:
placing holes in said shim to align with said attachment holes.

18. The method of claim 14 further comprising:
including an adjacent bore in said area.

19. The method of claim 14 further comprising:
placing a locator opening in said area.

20. The method of claim 19 further comprising:
extending a locator from said shim and
disposing said locator in said locator opening wherein said shim is flush with said surface.

21. The method of claim 14 further comprising: constructing said shim of a different material than said component or coating said shim.
